(19) United States
(12) Patent Application Publication
(10) Pub. No.: US 2003/0195913 A1
(43) Pub. Date: Oct. 16, 2003

(54) Shared multiplication for constant and adaptive digital filters

(76) Inventor: Charles Douglas Murphy, Chicago, IL (US)

Correspondence Address: CHARLES DOUGLAS MURPHY, 601 LINDEN PLACE #210, EVANSTON, IL, 60202, US

(21) Appl. No.: 10/118,635

(22) Filed: Apr. 10, 2002

(51) Int. Cl. G06F 7/52

(52) U.S. Cl. 708/620

(57) ABSTRACT

A machine or method used for reducing the implementation cost of digital filters that use multiplication operations. For each new input, a small look-up table of products is computed and stored. Weighting of the inputs when computing digital filter outputs can be accomplished using look-up table access, shifting, and addition. The invention can be used for constant filters or for adaptive filters. With constant filter coefficients, a small look-up table which exploits the properties of the various coefficient representations as a group is possible. With adaptive filters, a larger table may be needed, but can be used to reduce the multiplication cost of both filter output computation and filter adaptation. The invention is particularly useful in technologies where general multiplication is costly, such as field programmable gate arrays, application specific integrated circuits, and software running on general-purpose microprocessors. The invention can be used for high-precision computations without the need for large look-up tables. The invention can lead to digital filter implementation with reduced chip space, computation time, and power consumptions relative to implementations that do not share processing among multipliers.

### CROSS-REFERENCE TO RELATED APPLICATIONS

The invention is related to U.S. PTO application Ser. No. 09/976,920 with filing date Oct. 15, 2001 and entitled SHARED MULTIPLICATION IN SIGNAL PROCESSING TRANSFORMS, submitted as a separate application by Charles D. Murphy.

### STATEMENT REGARDING FEDERALLY SPONSORED RESEARCH OR DEVELOPMENT

Not applicable

### REFERENCE TO A MICROFICHE APPENDIX

Not applicable

### BACKGROUND

1. Field of Invention

The invention relates to number transforms used in signal processing, specifically to sharing computation when calculating products used in sequences of digital filter outputs.

2. Description of Prior Art

In a signal processing transform, input signals are manipulated to produce output signals. In digital signal processing, the input signals and the output signals are numbers, and a common form of manipulation is multiplication. Digital signal processing transforms which produce an output including non-zero contributions from more than one input are digital filters. Many people are familiar with the discrete Fourier transform (DFT) or with the discrete cosine transform (DCT) as examples of digital filters.

The DFT and the DCT each compute a set of outputs. Each output is a weighted sum of inputs. The weights are known constants, and the transform operates on blocks of inputs. Re-use of these transforms is usually on disjoint sets of inputs. However, there are many other types of digital filters. A common type of digital filter operates on a shifting window of inputs from an input sequence. Each output is a function of a unique set of inputs from the input sequence. Examples of this kind of filter include digital low-pass, high-pass, all-pass, and band-pass filters. These filters may have a finite impulse response (FIR) or an infinite impulse response (IIR). Filters can be linear or nonlinear.

Some filters have constant parameters such as tap coefficient value, length, and structure, while other filters have time-varying parameters. A common type of such an adaptive filter uses an error signal derived from filter outputs and known inputs or input statistics to update tap coefficient values.

The digital filters described above often rely on computing sums of products. Usually, it is possible to write each filter output as a function of a sum of weighted inputs. For instance, an N-point one-dimensional DFT accepts N inputs which are possibly complex and computes N outputs which are weighted sums of the inputs. A direct-form computation of a DFT requires approximately N² complex multiplications and approximately N² complex additions. However, for certain N values there are reduced-complexity or “fast” techniques for computing the DFT. These have computation costs on the order of N log₂ N complex multiplications and additions. Useful fast Fourier transform (FFT) techniques have simple recursive structures that provide for in-place computation and that have simple sorting techniques for producing outputs in the proper order.

In addition to FFT techniques for computing discrete and inverse discrete Fourier transforms, there are fast techniques for related transforms such as the DCT. However, many commonly-used digital filters do not have special weight relationships that enable the recursive fast structures. Typically, computing one output of an N-input digital filter, with the output a weighted sum of inputs, requires N multiplication operations and N−1 addition operations.

For instance, a common structure used in many digital filters involves storing in order a portion of an input sequence. A corresponding ordered sequence of filter tap coefficients is also stored. To compute the filter output, a running sum is initialized to zero. Then, successive inputs and their corresponding weights for that output are multiplied to produce a sequence of products. After each product is computed, it is added to the running sum, and discarded. The weights and inputs are not changed during computation of the output. However, in preparation for computing the next output, one or more new inputs may replace stored inputs that are no longer needed. Also, the tap coefficients may be updated according to an adaptation algorithm.

The main feature of the structure just described is a multiply-accumulate operation, sometimes referred to by the acronym MAC. A product is produced via multiplication, and then added to the running sum, or accumulated. MAC circuits or instruction sequences result in efficient use of memory resources. Inputs that are used in computing multiple filter outputs are not changed, and weights are not changed until—if and when—changes are needed. Because the products are added to the running sum immediately, there is no need to store large numbers of products.

A key challenge in designing practical implementations of digital filters is that the multiply operations described above may have high cost, when overall low cost is desired. In particular, multipliers may be very costly relative to addition or subtraction operations in some technologies, such as field-programmable gate arrays, software running on a general-purpose microprocessor, and application-specific integrated circuits. The cost may be measured in terms of power consumed, chip space occupied, or time required to complete product computation.

A general multiplier accepts two inputs, each of which can take on any value permitted by respective finite-precision numeric formats. The general multiplier circuitry or instruction sequence can compute the product of the two numbers. Because it can accommodate a large set of possible input pairs, a general multiplier is very flexible, but may be very expensive to implement.

An alternative to a general multiplier is a constant multiplier, in which one of the inputs is required to be a constant. The product of the one variable input and the constant can be computed with low cost by exploiting the known properties of the finite-precision numeric formats and the actual representation of the constant. A drawback of a constant multiplier is that it is much less flexible than a general multiplier. However, this may not be a problem when a constant multiplier is used in a dedicated digital filter computation for a digital filter that has constant coefficients.

Another alternative to a general multiplier uses pre-computed look-up tables containing the products of filter coefficients and all possible inputs. If the number of allowed inputs and the number of filter coefficients are both small, the table may have a reasonable size. An advantage of the look-up table is that a product can be computed by accessing its location in the table. A disadvantage is that the table may require a large amount of memory for storage of table members, particularly if the number of allowed inputs or the number of allowed coefficient values are large. In an adaptive filter, while the number of coefficients at any given moment may be small, the number of allowed coefficients may be very large.

Another technique for reducing the overall cost of computing multiple products of input numbers appears in US PTO application SHARED MULTIPLICATION IN SIGNAL PROCESSING TRANSFORMS having filing date Oct. 15, 2001 and filing Ser. No. 09/976,920. This application proposed sharing intermediate and/or final results of one product computation with another product computation involving the same input. In other words, a filter input may appear with differing weights in different filter outputs. Rather than computing each weight applied to the input separately, they are calculated jointly.

The idea of the prior art application is that in a particular finite-precision numeric format, any two number representations of differing number values may have similar patterns of representation element values. A simple decimal example is that 120200 is ten times 12020, which is ten times 1202. Supposing one had computed the product of a number and 1202. By shifting the result one digit left from the decimal point, one can implement multiplication by ten, thus producing the product of the number and 12020. In digital computing, however, most number representations have binary representation elements. Numbers that appear dissimilar in a decimal format may exhibit simple relationship descriptions in a binary format such as two's complement.

There are other ways to reduce the implementation cost of a digital filter. One way is to use a shorter filter, that is, a filter which has a small number of filter taps rather than a large number of filter taps. This results in an immediate reduction of the number of multiplications required for direct form computation of a sum of products. A disadvantage of short filters is that they may not be able to meet requirements such as frequency selectivity and filter ripple.

In adaptive filters, there are a variety of possible adaptation techniques. Generally speaking, very simple adaptation techniques have low implementation cost, but may either fail to cause the filter parameters to converge to desired value or may cause the parameter values to converge too slowly. More complicated adaptation techniques may have better convergence properties, but at the cost of a large number of arithmetic operations, particularly multiplications. With either simple or complicated adaptation techniques, it is possible to reduce the implementation cost by reducing the frequency of adaptation. Of course, this also slows convergence.

The US PTO application SHARED MULTIPLICATION IN SIGNAL PROCESSING TRANSFORMS by the author of the present invention proposed shared multiplication in the context of signal processing transforms with constant coefficients, such as discrete Fourier transforms and discrete cosine transforms. As mentioned above, these are block transforms in which several inputs in a block each contribute to several outputs in a block. While the author mentioned applicability of the idea to digital filters such as pulse shaping filters, he did exploit any of the unique features of digital filters in the time domain or with adaptive filter coefficients.

The disadvantages of prior art multipliers used in constant and adaptive digital filters are the following:

a. Fast techniques for computing digital filter outputs exist for the discrete Fourier transforms, discrete cosine transforms, and related transforms, but not for every digital filter.

b. Multiply-accumulate circuits make efficient use of available memory, but repeat computations that may appear in more than one product calculation.

c. A general multiplier which can compute any of the desired products in a signal processing transform and also other products may be very costly to implement, particularly in technologies such as application-specific integrated circuits, field-programmable gate arrays, and general purpose microprocessors.

d. A constant multiplier which can compute the product of one variable input and one constant input has lower cost than a general multiplier, but is also less flexible, and may not be particularly useful in an adaptive filter.

e. Look-up tables can replace multipliers, but may have too large a size when inputs and/or filter tap coefficients can take on a large number of possible values.

f. Using short filter lengths reduces implementation costs, but may result in poor filter performance.

g. Simple adaptive techniques for digital filters may have poor convergence properties, while more complicated adaptive techniques with good convergence properties may require large numbers of multiplication operations.

h. Shared multiplication techniques have been proposed for signal processing transforms with constant coefficients, where common properties of numbers and products are known during the multiplier design process.

### SUMMARY

The present invention is a technique for computing products over multiple indices of a digital filter using shared multiplication and look-up tables.

Objects and Advantages

Accordingly, several objects and advantages of the present invention are that:

a. Using said invention, the implementation cost of a digital filter that uses multiplication operations can be reduced.

b. Said invention can be used to reduce the cost of computing outputs of digital filters with constant coefficients.

c. Said invention can be used to reduce the cost of computing outputs of digital filters with adaptive coefficients.

d. Said invention can be used to reduce the cost of multiplication operations used in adaptation of adaptive digital filters.

e. Said invention can be used with inputs, filter taps, and outputs that have very high precision, without having correspondingly large lookup tables.

Further objects and advantages of the invention will become apparent from a consideration of the drawings and ensuing description.

### DRAWING FIGURES

In the drawings, closely related figures have the same number but different alphabetic suffixes.

FIG. 1 shows the 16-bit two's complement representations of two filter coefficients.

FIG. 2A shows a 16-element look-up table of products of a number.

FIG. 2B shows a 3-element look-up table of products of the number.

FIG. 3A shows the look-up table of FIG. 2A used to compute the product of the number and the first filter coefficient.

FIG. 3B shows the look-up table of FIG. 2B used to compute the product of the number and the first filter coefficient, and also a possible decomposition of the second filter coefficient.

### REFERENCE NUMERALS IN DRAWINGS

10 a decimal value of the first coefficient

12 a decimal value of the second coefficient

14 a 16-bit two's complement representation of the first coefficient

16 a 16-bit two's complement representation of the second coefficient

18 a first number

20 a 16-bit two's complement representation of the first number

22 a 16-bit two's complement representation of five times the first number

24 a 16-bit two's complement representation of eleven times the first number

26 a first four-bit portion of the first coefficient

28 a second four-bit portion of the first coefficient

30 a third four-bit portion of the first coefficient

32 a three-bit portion of the first coefficient

34 a first 16-bit two's complement representation, not shifted

36 a second 16-bit two's complement representation, shifted left four bits

38 a first addition result

40 a third 16-bit two's complement representation, shifted left eight bits

42 a second addition result

44 a fourth 16-bit two's complement representation, shifted left twelve bits

46 a third addition result

48 the final result

50 the decimal value of the final result

52 a three-bit portion of the first coefficient

54 a fourth four-bit portion of the first coefficient

56 a one-bit portion of the first coefficient, shifted left twelve bits

58 a first four-bit portion of the second coefficient

60 a one-bit portion of the second coefficient

62 a second four-bit portion of the second coefficient

64 a third four-bit portion of the second coefficient

66 a fifth 16-bit two's complement representation, shifted left one bits

68 a sixth 16-bit two's complement representation, shifted left five bits

70 a first sum

72 a seventh 16-bit two's complement representation, shifted left twelve bits

74 a second sum

76 a 16-bit two's complement representation of the first desired product

78 a decimal value of the first desired product

### DESCRIPTION—DIGITAL FILTERS

One type of signal processing transform which typically relies heavily on the use of both multiplication operations and addition operations is the digital filter. Digital filters are often used to process a large set of signals by repeated application to relatively small subsets of the signals. Because their repetitive use, digital filters are often implemented in specialized hardware or software that is designed specifically to have low resource cost.

y[n]=Σ_{k=0 to N-1}×[n−k]w[n,k] (1)

A digital filter may operate on a signal by signal basis. Equation (1) describes the output of a linear filter, which computes at each index n a weighted sum of input numbers. In equation (1), y[n] is the filter output at index n, x[n] is the filter input at index n, and w[n,k] is a weight which depends on both the index n and the index k.

Note that in equation (1), k takes on values between 0 and (N−1). There are up to N non-zero weights. This means that the filter is a finite impulse response (FIR) filter with length N. Since the output at index n depends on inputs with indices less than n, when the index n represents units of time, the filter is causal.

If w[n,k] does not change as a function of n, the weights are constant. If the index n represents time, then equation (1) describes a linear time-invariant FIR filter. On the other hand, if w[n,k] does change as a function of n, the weights are not constant. In this case equation (1) describes a time-varying filter.

At index n, input x[n] is weighted by w[n,0], input x[n−1 ] is weighted by w[n,1], and so on up to input x[n−N+1], which is weighted by w[n,N−1 ]. At index n+1, input x[n+1] is weighted by w[n+1,O], input x[n] is weighted by w[n+1,1], and so on up to input x[n−N+2], which is weighted by w[n+1,N−1 ]. At each index value a new input is used to compute the output, an old input is no longer needed and may be discarded, and old inputs that are still needed appear with different weights. Thus, the filter operates on a signal by signal basis.

For an arbitrary set of weights, it is possible to compute y[n] at each index n using N multiplication operations and (N−1) addition operations. If the weights and the inputs are permitted to take on any values supported by their finite-precision numeric formats, the multiplication operations are general multiplication operations and may have a corresponding high implementation cost. If, on the other hand, the weights, the inputs, or both have restrictions on allowed values, it may be possible to replace general multiplication operations with reduced-cost multiplication techniques such as constant multiplication or non-constant, non-general multiplication.

A digital filter may operate on blocks of signals that do not overlap between computations of the filter outputs. The discrete Fourier transform (DFT) is a digital filter that computes discrete Fourier coefficients of a sequence of inputs. Usually when a DFT is applied repeatedly, each input number contributes to the outputs of one full DFT computation. The DFT of one block of inputs is computed separately from the DFT of the next block of inputs.

X[k]=Σ_{n=0 to N-1}×[n] exp({−j2 πnk/N}) for k=0, 1, . . . ,N−1 (2)

Equation (2) shows a common closed-form expression of a DFT. This DFT has N outputs X[k] indexed by k. The N inputs to the transform are x[n] indexed by n. Since the DFT operates on a block of inputs, each index n corresponds to an ordered location within the block. The weights are unit-amplitude complex exponentials which are known and constant.

It is possible to compute the N outputs of a DFT by treating each output as a separate linear combination of the inputs. Using this direct form computation requires N complex multiplication operations and (N−1) complex addition operations for each of the N outputs, or approximately N² of each operation. Since the weights are known constants, one can apply reduced-complexity multiplication techniques such as constant multiplication. Also, for certain values of n, k, and N, the weights may be purely real, purely imaginary, or with real and imaginary components of equal amplitude, in which cases one can replace multiplication with other low-cost operations.

A special feature of the discrete Fourier transform, the inverse discrete Fourier transform, and related transforms such as discrete cosine transforms and discrete sine transforms, is that the outputs can be computed using so-called “fast” techniques. For the DFT, fast computation techniques exploit the fact that a DFT of non-prime size can be decomposed into sets of DFT computations of smaller size. Fast Fourier transform techniques can reduce the complexity from N² multiplication and addition operations to N log N multiplication operations, with the logarithm of base 2. Moreover, the N log N multiplication operations involve known constants, so that reduced-cost multiplication techniques can be employed.

Fast transform structures such as the decomposition to multiple transforms of smaller size depend on special properties of groups of filter coefficients. The special properties of DFT, inverse DFT, discrete cosine transform, and discrete sine transform coefficients exist in theory and are well-approximated in digital transform implementations. However, many digital filters such as pulse-shaping filters and spectral filters (low-pass, high-pass, notch, band-pass, all-pass, and others) do not have coefficients that are amenable to such decomposition. The coefficients may not even have fixed relationships if they are part of an adaptive filter.

In other words, while there are fast computation structures for a few signal processing transforms that have constant coefficients with particular special mathematical relationships, many digital filters involve computations in the form of equation (1) in which an input appears in successive outputs with differing weights that may or may not be known when the input is first used. Techniques for reducing the implementation cost of such transforms would be very useful.

### DESCRIPTION—THE PREFERRED EMBODIMENT

The preferred embodiment of the invention is a machine used in a digital filter. It includes means for computing a set of products of a first number and means for storing these products in a look-up table. It also includes means for accessing the look-up table to provide a first member of the set of products and means for accessing the look-up table to provide a second member of the set of products. It also includes means for computing a first product of the first number and a first filter coefficient using the first member and means for computing a second product of the first number and a second filter coefficient using the second member.

The first member and the second member in the preferred embodiment may in fact be the same member of the look-up table, or they may be different members of the look-up table. The first number may be a filter input, in which case the look-up table holds a set of weighted inputs. The weights may or may not be identical to one or more filter coefficients. It is also possible that the first number is not a filter input, but a function of a filter input.

The preferred embodiment of the invention uses the concept of shared multiplication, which was proposed in the US PTO application SHARED MULTIPLICATION IN SIGNAL PROCESSING TRANSFORMS. The preferred embodiment of the invention uses a specific kind of shared multiplication. The set of products that is computed and stored in the look-up table contains, in effect intermediate calculation results. Since the means for computing the first product and the means for computing the second product both use numbers from the look-up table, they do not have to repeat computation of the intermediate calculation results. For instance, if the means for computing the first product and the means for computing the second product use the same member of the table, that table product is computed once. Without shared multiplication, that table product would be computed twice.

The look-up table can be accessed more than once in computing the first product, as will be discussed below. In this case, a small look-up table can be used in computing a high-precision product. Also, the look-up table can be accessed to provide members for use in computing the products of the first number and more than two coefficients. In this case, a small look-up table can be used many times in computing different products.

### DESCRIPTION—ALTERNATIVE MACHINE EMBODIMENTS

In an alternative embodiment, the first product computed by the machine of the preferred embodiment is used to compute a first output of the digital filter, and the second product computed by the machine of the preferred embodiment is used to compute a second, different output of the digital filter. In this alternative embodiment, the product calculations are shared between weighting of the first number for the first output of the digital filter and weighting of the first number for the second output of the digital filter.

For instance, referring back to equation (1), the first number might be x[n], the first filter coefficient might be w[n,0], and the second filter coefficient might be w[n+1,1]. The first product, x[n] w[n,0], appears in the output y[n]. The second product, x[n] w[n+1,1], appears in the output y[n+1].

In another alternative embodiment, the machine of the preferred embodiment is restricted to having constant first and second filter coefficients, and a set of products and hence a look-up table—which does not contain a subset of products from which the product of the first number and every coefficient value can be computed but which does contain a subset of products from which the product of the first number and every allowed coefficient value can be computed. The subset can be a strict subset of the set of products, or the set of products itself.

When the coefficients by which the first number is multiplied are constants, it is possible to examine the representations of the coefficients and identify a limited set of intermediate results or partial products that are needed to compute the desired products. It is possible to identify patterns of representation element values in a given coefficient representation, and patterns of representation element values common to two or more coefficient representations. Representation element value patterns that do not show up or that are to be implemented within a look-up table member or as combinations of look-up table members do not need to be included in the look-up table.

In still another alternative embodiment, the machine of the preferred embodiment is modified by requiring that the first filter coefficient not be a constant coefficient and that the first product be used in computing a first output of the digital filter. Thus the invention can be applied to computing the output of a time-varying or adaptive digital filter. Note that even though the first filter coefficient is not a constant, there is no requirement that it be allowed to take on every value permitted by its finite-precision numeric format. It may be possible that restrictions on the allowed values of the variable first filter coefficient permit a look-up table that does not contain a set of products from which the product of the first number and every coefficient value can be computed.

In still another alternative embodiment, the preferred embodiment is modified by requiring inclusion of means for adapting parameter values of the digital filter and by requiring that the first product and the second product be used in the adapting means. Thus, the invention can be applied to the adaptation techniques used to change filter parameters such as the filter coefficient values. Examples of these adaptation techniques are LMS techniques, Kalman or direct-form RLS techniques, and fast RLS techniques. Often, the adaptation requires many more multiplication operations than computation of the filter outputs. The invention can be used in matrix and vector multiplication operations to reduce the implementation cost of the multiplications.

Finally, another alternative embodiment restricts machine of the preferred embodiment by including means for using the first product to compute a first output of the digital filter and also including means for adapting parameter values of the digital filter using the second product. Thus, output computations and adaptation computations can share multiplication, resulting in reduced implementation complexity.

### DESCRIPTION—RECURSIVE SHARED MULTIPLICATION

In other alternative embodiments, calculation of the set of products stored in the look-up table in the preferred embodiment of the invention uses recursive shared multiplication. In one such alternative embodiment, the means for computing the set of products produces a first member to store in the look-up table and a second member to store in the look-up table. Calculation of the second member uses the first member. In another such alternative embodiment, the means for computing the set of products produces a first member, a first intermediate term, and a second member. The second member is computed using the first intermediate term. The first member and the second member are stored in the look-up table, but the first intermediate term is not stored in the look-up table.

These alternative embodiments attempt to reduce the cost of computing the set of products for storage in the look-up table. Depending on the size of the look-up table and the desired products it contains, the cost reduction may or may not be significant. Large look-up tables have the possibility of large cost reduction. However, large look-up tables may require large amounts of storage.

### DESCRIPTION—OTHER ALTERNATIVE EMBODIMENTS

In another alternative embodiment of the invention, the first number is a member of a strict subset of the values supported by the first number's finite-precision numeric format and the means for computing the set of products of the first number cannot compute the set of products for an arbitrary first number value. For example, the first number could be a member of a small set of symbols from a symbol constellation. As a group, the members of such a small set may have special properties that enable low-cost computation of the first number products which become members of the look-up table. This means that the means for computing the set of products of the first number can be a non-general multiplier with lower implementation cost than that of a corresponding general multiplier.

In another alternative embodiment, the look-up table contains a set of products of a first number for a time, and then contains a set of products of a second number. For instance, in a typical FIR filter with one new input and one new output for each sample index, a table for a given input can be created and stored when that input becomes available to the digital filter. The table can be used for computing contributions of that input to outputs at various indices. When the input no longer contributes to outputs, the memory locations in which the look-up table members are stored can be re-used for storing a set of products corresponding to another input. Such an alternative embodiment combined with circular addressing of table locations enables computational structures in which tables are computed and stored once, and subsequently not shifted to new memory locations.

### DESCRIPTION—METHOD CLAIMS

The above description related primarily to machine embodiments of the invention. However, there are analogous claims for method embodiments. The method claims are for embodiments which are processes used in digital filters. The method claims are intended to cover implementations of the methods of the present invention that are used for digital filters with constant coefficients, that are used for digital filters with variable coefficients, and that are used to implement shared multiplication for filter output computations, coefficient adaptation, and both filter output computation and coefficient adaptation. The method claims are also intended to cover implementations of methods with reduced-cost multiplication methods used in computing the set of products and implementations of methods with over-writing of look-up table values with new values once the old values are no longer needed.

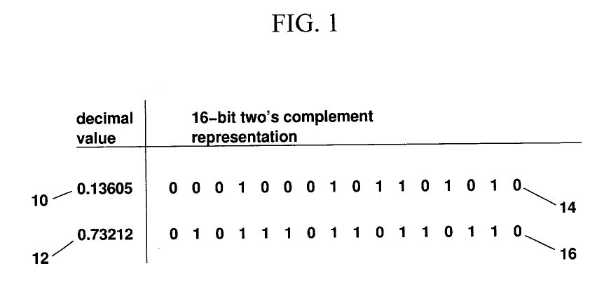

Description—FIG. 1

FIG. 1 shows the two's complement representations of two numbers which are possible filter coefficients. Indicated in the figure are a decimal value of the first coefficient 10, which is 0.13605, and a decimal value of the second coefficient 12, which is 0.73212. Also indicated are a 16-bit two's complement representation of the first coefficient 14 and a 16-bit two's complement representation of the second coefficient 16.

Examining the decimal value of the first coefficient 10 and the decimal value of the second coefficient 12, it is not apparent that there are any special relationships between the two numbers, such as the first being an integer multiple of the second, or such as the first being a power-of-two multiple of the second. However, it is clear that each of the two's complement representations contains bit patterns such as “1 1”, “1 0 1”, and “1 0 1 1”.

Advantages of two's complement number representations are that addition can be accomplished by addition of corresponding bits, that subtraction can be implemented by two's complement negation followed by addition of corresponding bits, and that multiplication can be accomplished via addition of shifted products in much the same way that decimal multiplication is carried out by many people. In other words, to compute the product of the two's complement representation of the first coefficient 14 or the two's complement representation of the second coefficient 16 and a number, one need only add shifted replicas of the number. Where a bit in the two's complement representation of a coefficient is “1”, a shifted replica of the number is added to a running sum, and where a bit in the two's complement representation of a coefficient is “0”, a shifted replica of the number is not added to the running sum.

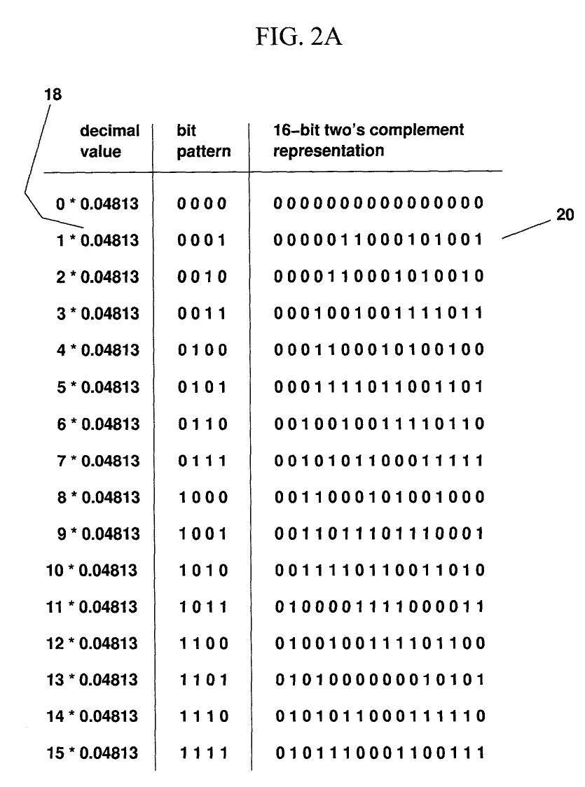

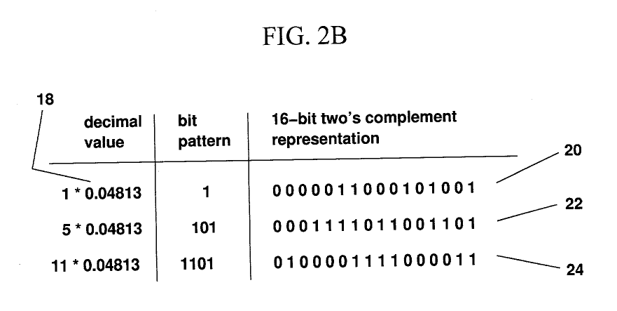

Description—FIG. 2A and FIG. 2B

In the invention, a first number is to be multiplied by a first filter coefficient to produce a first product, and also to be multiplied by a second filter coefficient to produce a second product. As a first step, a look-up table of products of the first number is computed and stored.

FIG. 2A shows a look-up table having 16 elements. The table includes a column listing decimal values, a column listing bit patterns, and a column listing 16-bit two's complement representations. The 16 elements of the look-up table are the two's complement representations of a first number 18 which has a decimal value of 0.04813 and a 16-bit two's complement representation of the first number 20 which is a bit string 0 0 0 0 0 1 1 0 0 0 1 0 1 0 0 1. The approximate decimal values of the other representations are shown in the decimal value column. The exact 16-bit two's complement representations derived from the first number two's complement representation 20 are shown in the 16-bit two's complement representation column. Finally, the bit pattern column shows the unsigned binary integer corresponding to the various products of first number 18.

One interpretation is that the table in FIG. 2A represents the set of all partial products of four-bit unsigned integers and the absolute value of first number 18. To obtain the negatives of these products, one need only negate the corresponding table element. Alternatively, one might construct a table including products of the first number 18 and partial products. In a practical implementation, the two's complement representations might be computed on a chip and stored in successive memory registers. Then, a pointer to the first location can indicate the start of the table, with positive offsets indicating the location of the corresponding product. For this table, the product of 3 and the first number 18 is offset by 3 places from the start of the table.

Note that while the table of FIG. 2A contains 16 elements which are 16-bit two's complement representations of products of the first number 18, it may not be feasible to have a larger table, such as one that contains all possible products of the first number 18 and allowed coefficient values or such as one that contains the 16 products for of all allowed first number values. For instance, there are 2¹⁶ or 65536 possible 16-bit two's complement number representations. If the first number can take on any of these values, a comprehensive table with 16 products for each would required 1048576 stored representations. Similarly, if there are only 6 allowed first number representations, but any coefficient can take on any 16-bit two's complement representation, a comprehensive table with all products of the allowed first number representations would require 393216 stored representations.

FIG. 2B shows a second look-up table having 3 elements. As with the table of FIG. 2A, the 16-bit two's complement representations of this second table are products of the first number 18 having a decimal value of 0.04813. The products included in the table are the 16-bit two's complement representation of the first number 20, the 16-bit two's complement representation of five times the first number 22, and the 16-bit two's complement representation of eleven times the first number 24.

As with the table of FIG. 2A, the table of FIG. 2B includes a column of decimal values and a column of bit patterns. The decimal values are one multiplied by the first number 18, five multiplied by the value of the first number, and eleven multiplied by the value of the first number. The 16-bit two's complement representation of five times the first number 22 and the 16-bit two's complement representation of eleven times the first number 24 are derived from the 16-bit two's complement representation of the first number 20, so the decimal values of each are only approximate.

The bit patterns are shown as having one, three, and four bits respectively. This is to emphasize the fact that a look-up table does not have to be comprehensive. One useful bit pattern can be four bits long, while another useful pattern can be three bits long, and a third useful pattern can be only one bit long. Having one bit pattern of a certain length represented in the table does not mean that all bit patterns of that length must be represented in the table. This is particularly important in digital filters which have constant tap coefficients, where all the bit patterns are known in advance. It may also be applicable to adaptive filters when non-constant tap coefficients nonetheless have suitable restrictions on the possible values they may assume.

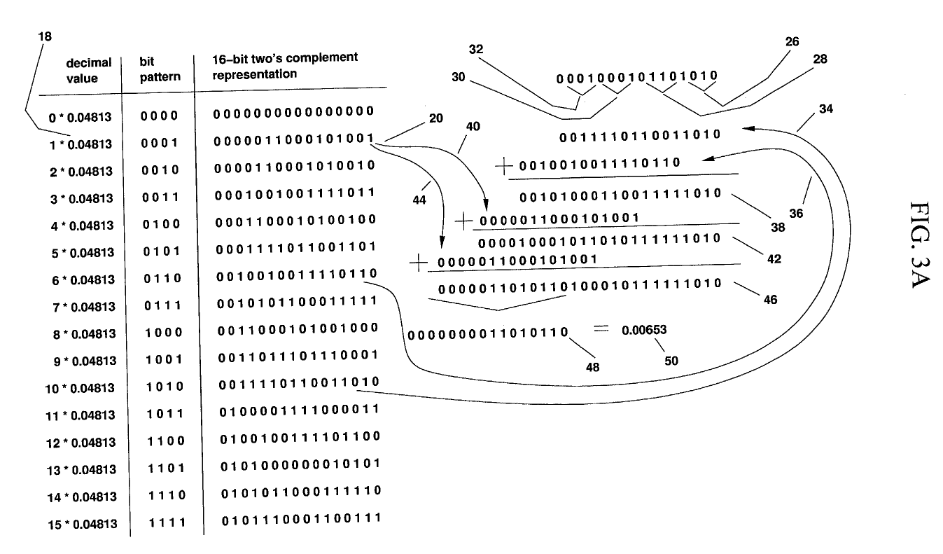

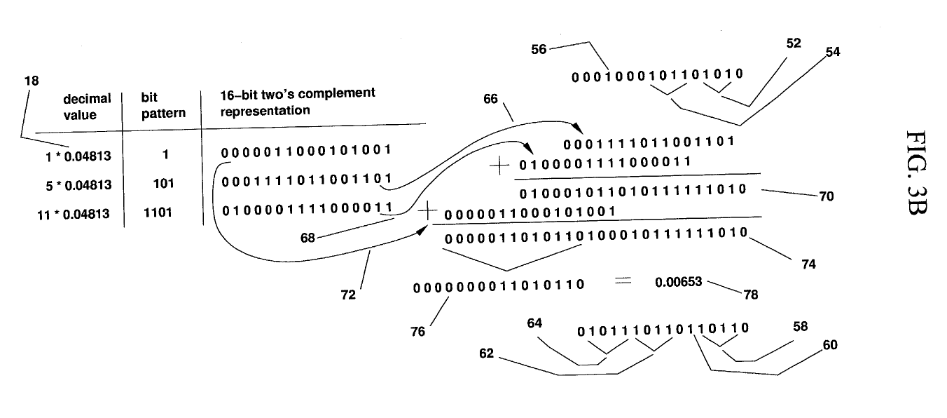

Description—FIG. 3A

In the present invention, look-up tables contain products of a first number. The products are used to compute a first product equal to the product of the first number and a first filter coefficient, and also to compute a second product equal to the product of the first number and a second filter coefficient. FIG. 3A and FIG. 3B suggest two different techniques for computing the multiple desired products. In each case, the first number 18 of FIGS. 2A and 2B is used. It has a decimal value of 0.04813 and a 16-bit two's complement representation of 0 0 0 0 0 1 1 0 0 0 1 0 1 0 0 1. The first filter coefficient of FIG. 1 is multiplied by the first number 18. The decimal value of the first coefficient 10 is 0.13605 and the 16-bit two's complement representation of the first coefficient 14 is 0 0 0 1 0 0 0 1 0 1 1 0 1 0 1 0, as shown in FIG. 1. The product of 0.13605 and 0.04813 is 0.00654.

FIG. 3A shows use of the 16-element table of two's complement representations of products of the first number 18 from FIG. 2A to compute the product of the first number 18 and the 16-bit two's complement representation of the first coefficient 14. In FIG. 3A, the first number 18 and the 16-bit two's complement representation of the first number 20 are indicated in the table.

The basic premise of the technique suggested in the figure is that the table includes all four-bit unsigned binary products of the first number 18. In the first step, a first four-bit portion of the first coefficient 26 having a bit pattern 1 0 1 0 is used to look up a first 16-bit two's complement representation, not shifted 34 in the look-up table. A second four-bit portion of the first coefficient 28 having a bit pattern 0 1 1 0, and which is shifted by four bits to the left of the first four-bit portion of the first coefficient 26, is used to look up a second 16-bit two's complement representation, shifted left four bits 36. The two representations are added together to produce a first addition result 38.

Next, a third four-bit portion of the first coefficient 30 having a bit pattern 0 0 0 1, and which is shifted by eight bits to the left of the first four-bit portion of the first coefficient 26 and by four bits to the left of the second four-bit portion of the first coefficient 28 is used to access a third 16-bit two's complement representation, shifted left eight bits 40. This is added to first addition result 38 to produce a second addition result 42. Then, a three-bit portion of the first coefficient 32 shifted to the left four bits from the third four-bit portion of the first coefficient 30 is used to access a fourth 16-bit two's complement representation, shifted to the left twelve bits 44. This is added to second addition result 42 to produce a third addition result 46.

As a result of the multiplication of two numbers with fifteen bits of precision each, the binary “decimal” place corresponding to the most-significant non-sign bit must be shifted a total of fifteen places to the left. Thus, the portion of the third addition result 46 is selected as the final result 48. Note that in the 16-bit two's complement representation of the final result 48, fifteen bits in third addition result 46 have been discarded, while three additional bits have been included, per the two's complement format. Finally, we see that the decimal value of the final result 50 is 0.00653. Since the size of the LSB is 2⁻¹⁵ or approximately 0.00003, the value of the final result is what was expected.

The procedure described just above and illustrated in FIG. 3A can be used for multiplication of the first number 18 by any positive coefficient in 16-bit two's complement format. As such, it is useful when there are a large number of possible coefficient values, which may be the case in adaptive digital filters. By replacing the two's complement representation of the first coefficient 14 of FIG. 1 with the two's complement representation of the second coefficient 16 of FIG. 1, it is possible to use the multiplication technique just described to compute the product of the first number 18 and the second coefficient.

While the computations of FIG. 3A did not take into account the possibility of the number or the filter value being negative, it is easy enough to modify the technique to accommodate negative number multiplication. For instance, one might include steps at the start of table construction to negate a negative input and to store a bit indicating that the input is in fact negative. Then, after computing what are negated desired products of the input, the result could be negated to produce desired products. Similarly, multiplying by a negative filter coefficient could be implemented by negating it, using the procedure described in FIG. 3A, and negating the results to produce desired products.

FIG. 3A is intended to demonstrate that a look-up table can be used in a general multiplication operation. By changing the members of the look-up table and the coefficient value, a common procedure can be used to compute different products. There are costs associated with creating the table. However, these can be amortized over use of each table for computing multiple desired products. Effectively, the costs are shared among multiple multiplication operations.

Description—FIG. 3B

As was mentioned earlier, in constant filters, the filter coefficients are fixed and known. Since the coefficients do not vary, it is possible to exploit patterns in the representations of the allowed filter coefficient values so that look-up tables have reduced size and reduced creation cost and so that multiplication has reduced cost.

FIG. 3B shows use of the three-element table of FIG. 2B to compute the product of the first number 18 and the first filter coefficient of FIG. 1, and also suggests a decomposition of the second filter coefficient of FIG. 1 for similar desired product calculation. Recall that from FIG. 1 the decimal value of the first coefficient 10 is 0.13605 and that the 16-bit two's complement representation of the first coefficient 14 is 0 0 0 1 0 0 0 1 0 1 1 0 1 0 1 0. Also, the decimal value of the second coefficient 12 is 0.73212, and the 16-bit two's complement representation of the second coefficient 16 is 0 1 0 1 1 1 0 1 1 0 1 1 0 1 1 0. The product of 0.04813 and 0.13605 is 0.00654 and the product of 0.04813 and 0.73212 is 0.03523.

Referring to FIG. 3B, a three-bit portion of the first coefficient 52 is used to look up a fifth 16-bit two's complement representation, shifted left one bit 66, which has a bit patter 1 0 1. Also, a fourth four-bit portion of the first coefficient 54 which has a bit pattern 1 0 1 1 is used to look up a sixth 16-bit two's complement representation, shifted left five bits 68. The two shifted representations are added together to produce a first sum 70. Next, a one-bit portion of the first coefficient 56, which has a bit pattern 1, is used to look up a seventh 16-bit two's complement representation, shifted left twelve bits 72. This representation is added to first sum 70 to produce a second sum 74. Shifting the binary “decimal” place appropriately, a portion of second sum 74 forms a 16-bit two's complement representation of the first desired product 76. The decimal value of the first desired product 78 is 0.00653.

Also in FIG. 3B, there is a 16-bit two's complement representation of the second coefficient of FIG. 1A. FIG. 3B suggests that the product of the first number 18 and the second coefficient could be accomplished using four portions looked up in the table, shifted, and added. In particular, there are a first four-bit portion of the second coefficient 58 having a bit pattern 1 0 1 1, a one-bit portion of the second coefficient 60 having a bit pattern 1, a second four-bit portion of the second coefficient 62 having a bit pattern 1 0 1 1, and a third four-bit portion of the second coefficient 64 having a bit pattern 1 0 1 1.

Description—Costs

As has been mentioned, the costs of creating and storing the tables of FIG. 3A and of FIG. 3B are different. Also, the costs of computing the products of the first number and the filter coefficients differ.

The three-element table of FIG. 3B has both the smallest creation and storage costs. Only three 16-bit memory locations are needed. The table element corresponding to the bit pattern 1 is cost-free, since it is just the representation of the first number. The table element corresponding to bit pattern 1 0 1 can be generated using one shifting operation and one addition operation. The third table element can also be generated using one shifting operation and one addition operation, by making use of the previously-computed table element corresponding to bit pattern 1 1 0 1. Thus, the whole table can be computed using two addition operations and two shifting operations.

The product computation of the first number and the first coefficient detailed in FIG. 3B and the suggested decomposition of the second coefficient for similar processing require different operation sequences. Computing the first sum 70 requires two table accesses, with the looked-up number representations each shifted prior to adding. Computing the second sum 74 requires a table access, a shifting operation, and an addition.

Altogether, computation of the desired product with the first coefficient requires three table accesses, three shifting operations, and two additions. Since the second coefficient is decomposed into four portions rather than three, computation of the desired product of the second coefficient requires four table accesses, four shifting operations, and three additions.

A small table with limited bit patterns represented in its elements is best suited for filters with constant coefficients. For such filters, it is possible to fully exploit common bit patterns. Also note that the technique used for multiplication by each coefficient can differ. For instance, the multiplication of in FIG. 3B by the first coefficient can be accomplished using fewer operations than the multiplication by the second coefficient.

In the case of adaptive filters, the coefficients may take on a wide range of values even though at any given moment they may have only a few values. This means that a look-up table must be somewhat more complete than that of FIG. 2B. The 16-element table in FIG. 2A contains all four-bit unsigned bit patterns, and so can be used to compute the product of a first number and variable coefficients, provided appropriate accommodation for negative numbers and, most importantly, provided that no bit patterns with size larger than four are used.

In FIG. 3A, computation of the product of the first number and the first coefficient requires a total of four table accesses, three shifting operations, and three additions. This cost is the same that would be required to compute the product of the first number and the first coefficient in the same way. There can be no savings for special values (e.g. the coefficient happens to reach a representation of 0 0 0 0 0 0 0 0 0 0 0 0 1 1 1 1) unless additional detection and processing circuitry or steps are included.

Creation of the table of FIG. 2A has a higher cost than creation of the table of FIG. 2B. With entirely separate computations of each table member, bit patterns 0 0 1 0, 0 1 0 0, and 1 0 0 0 require one shift operation apiece. Bit patterns 0 0 1 1, 0 1 0 1, and 1 0 0 1 require one shift operation and one addition apiece. Bit patterns 1 1 0 0, 1 0 1 0, and 0 1 1 0 require two shift operations and one addition apiece. Bit patterns 0 1 1 1, 1 0 1 1, and 1 1 0 1 require two shift operations and two additions apiece. Bit pattern 1 1 1 0 requires three shift operations and two additions. Bit pattern 1 1 1 1 requires three shift operations and three additions. All told, twenty-four shift operations and seventeen add operations are required. Of course, the costs can be reduced by sharing the calculations used to compute the various products in the tables.

The examples of FIGS. 2A, 2B, 3A, and 3B show that the present invention can be used to implement comprehensive tables and general multiplication techniques or sparse tables and reduced-complexity—even constant—multiplication techniques. In terms of the cost of the product computations after the tables have been created, FIG. 3B demonstrated a small savings relative to FIG. 3A. For finite-precision numeric formats with more bits, the savings may increase. Also, with more desired products to be calculated (i.e. more coefficients), constant multipliers using the table offer increased savings.

Note also that there are many other finite-precision numeric formats. There are also different techniques for computing table members, different approaches to decomposing coefficients in order to select table members, and different orders of addition and shifting. Looked-up table members may be shifted left or right, and may be shifted or added in different orders. Also, different numbers of bits may be retained at each stage than the number shown in FIGS. 3A and 3B.

Description—Further Comments

The figures and accompanying discussion emphasized that the invention can be applied to multiplication of a first number by multiple filter coefficients. The filter coefficients may be constant, or adaptive. In either case, computing one output of an N-input or N-tap digital filter typical requires N multiplication operations and N addition operations. The invention can reduce the overall cost of implementing the N multiplication operations.

However, in adaptive filters, much of the computational complexity may reside in the adaptive update technique. For instance, the complexity might be polynomial, such as N² operations, or exponential, such as 2^{N} operations. Two claims cover use of the present invention in the context of filter adaptation. The intent is to reduce the overall cost of the multiplication operations used for adaptive update.

In simple adaptive techniques, such as a least-mean-square (LMS) algorithm or a gradient descent algorithm, filter taps are updated by adding at each update interval an error term comprising a scaled product of a difference between a desired and an actual output and a received or known signal. In these techniques, any tables generated for computing products of filter inputs and filter coefficients could also be used to compute error terms.

In more complicated adaptive techniques, such as recursive least-squares (RLS) or Kalman algorithms, filter taps are updated according to several stages of vector and matrix computations. Filter outputs and differences between desired and actual outputs are computed. Also, a Kalman gain vector is computed using an inverse correlation matrix and the filter inputs. The Kalman gain vector is then used to update the inverse correlation matrix, a procedure requiring approximately N² operations for an N-tap filter. Finally, the Kalman gain vector, or the inverse correlation matrix and the filter inputs, are multiplied by the vector of output differences and used to update the filter tap coefficients. In such a scenario, look-up tables used for computing desired product contributions of filter inputs to the filter outputs can also be used in computing products of filter inputs used in updating the Kalman gain vector, the inverse correlation matrix, and the filter coefficients.

There are also fast RLS algorithms with linear complexity, lattice filter algorithms, blind adaptive techniques, and other adaptation technique for digital filters. The present invention can be applied to all of them. Note that prior art has proposed multiplication for digital filter output computation using table look-up in which partial products of filter coefficients are table members. This may be useful for digital filters with constant coefficients, but is likely to be much less useful when the coefficients may vary. While above it is suggested that the invention could be used with look-up tables for computing outputs and the same look-up tables for computing adaptation terms, it is also possible to view the adaptation as a digital filter, with—for instance—output differences, Kalman gain vector values, or inverse correlation matrix values that are first numbers to be put in tables that are used for multiple product calculations. In this case, new tables may be generated for the adaptation, to be used per the claims of the present invention.

### CONCLUSION, RAMIFICATIONS, AND SCOPE

The reader will see that the present invention has several advantages over prior art techniques for implementing digital filters that use multiplication operations. A common digital filtering technique involves computing sums of products. At each index, a different set of inputs is multiplied by a set of different non-zero weights and added to produce desired sums. The weights may be constant or may vary, with changes made according to an adaptation technique. The invention exploits the idea of sharing calculations involving a first number that appears in more than one product weighted by more than one filter coefficient. This allows digital filter implementations which have reduced cost for the required multiplication operations.

In a preferred embodiment of the invention, a set of products of a first number is computed and stored in a look-up table. The set of products has at least two members. In the preferred embodiment, a first product equal to the product of the first number and a first filter coefficient is computed using a first member of the look-up table, and a second product equal to the product of the first number and a second filter coefficient is computed using a second member of the look-up table. In this way, the members of the look-up table can be used in more than one product computation, so the product computations involved shared multiplication.

The first product and the second product can be used in a variety of ways. In an alternative embodiment of the invention, both products are used in computing digital filter outputs. For a time-domain filter, the two products can be used in outputs at two different time indices. In an alternative embodiment of the invention, both products are used in adaptation techniques that change the values of digital filter parameters. In another alternative embodiment of the invention, the first product is used in computing a digital filter output and the second product is used in adaptation techniques that change the values of digital filter parameters.

The invention can be used in digital filters with constant coefficients and also in digital filters with variable coefficients. In the case of constant coefficients, it is possible to have a small look-up table that exploits the properties of the coefficients by which the first number is multiplied.

The invention is useful in digital signal processing transforms that do not have fast computation structures. A discrete Fourier transform can be computed using fast techniques that exploit recursive decomposition into discrete Fourier transforms of smaller size, but a digital Butterworth filter does not allow the same type of structure. However, the present invention can be applied to a digital Butterworth filter and to direct-form discrete Fourier transforms, as well as to related transforms. It can also be applied to digital filters such as channel equalizers, pulse-shaping filters, and system models in system controllers.

The invention is not limited to particular number representations or to particular applications. Signal processing transforms that use digital filters with multiplication operations are used in digital communications, radar, sonar, astronomy, geology, control systems, image processing, and video processing. Technologies used to implement signal processing transforms include hardware technologies such as application specific integrated circuits and field-programmable gate arrays and software technologies such as multiplication on a general-purpose microprocessor.

The invention can be used as part of a circuit or software instruction sequence design library. The invention can be included as part of a computer program that automatically generates efficient machines and methods for hardware circuitry and software instruction sequences.

The description above contains many specific details relating to digital filters, adaptive techniques, finite-precision numeric formats, representation elements, number values, computational complexity measures, discrete Fourier transforms, discrete cosine transforms, discrete sine transforms, inverse transforms, FFT techniques, hardware technologies, software technologies, and signal processing applications. These should not be construed as limiting the scope of the invention, but as illustrating some of the presently preferred embodiments of the invention. The scope of the invention should be determined by the appended claims and their legal equivalents, rather than by the examples given.

I claim:

1. A machine used in a digital filter, comprising:
a. means for computing a set of products of a first number, said set of products having at least two members
b. means for storing said set of products in a look-up table
c. means for accessing said look-up table to provide a first member of said set of products
d. means for computing a first product equal to the product of said first number and a first filter coefficient, said first means using said first member of said set of products
e. means for accessing said look-up table to provide a second member of said set of products
f. means for computing a second product equal to the product of said first number and a second filter coefficient, said second means using said second member of said set of products
whereby computation of said first product and computation of said second product both use members of said set of products from said look-up table, so that computational results are shared and multiplier implementation cost can be reduced.

2. The machine of claim 1, further including:
a. means for computing a first output of said digital filter using said first product
b. means for computing a second output of said digital filter using said second product, said second output not being the same output as said first output
whereby said set of products stored in said look-up table can be used in computing outputs of said digital filter at more than one index value, even though the coefficients of the filter may change from index value to index value.

3. The machine of claim 1 in which:
a. said first filter coefficient is a constant coefficient
b. said second filter coefficient is a constant coefficient
c. said set of products does not contain a subset of products from which the product of the first number and every coefficient value can be computed
d. said set of products does contain a subset of products from which the product of the first number and every allowed coefficient can be computed
whereby said look-up table can be small in size and yet still contain the products necessary for computing said first product, said second product, and products of said first number and other coefficients of said digital filter.

4. The machine of claim 1, in which said first filter coefficient is not a constant coefficient, further including means for using said first product in computing a first output of said digital filter, whereby said look-up table can be used for shared multiplication and implementation cost reduction in computing outputs of adaptive filters.

5. The machine of claim 1, further including means to adapt parameter values of said digital filter, said means using said first product and said second product, said first product and said second product not being the same product, whereby said look-up table can be used for shared multiplication and corresponding implementation cost reduction in adaptive filters which use adaptation techniques such as least-mean-square (LMS) techniques, recursive least-square (RLS) techniques, fast RLS techniques, and Kalman techniques, among others.

6. The machine of claim 1, further including:
a. means for computing a first output of said digital filter using said first product
b. means for adapting parameter values of said digital filter using said second product
whereby said set of products stored in said look-up table can be used in computing an output of said digital filter and also in adaptive filters which use adaptation techniques such as least-mean-square (LMS) techniques, recursive least-square (RLS) techniques, fast RLS techniques, and Kalman techniques, among others.

7. The machine of claim 1 in which:
a. said means for computing said set of products produces a first member of said set of products
b. said means for computing said set of products produces a second member of said set of products using said first member
whereby said means of computing said set of products for said look-up table can use shared multiplication in order to reduce implementation costs.

8. The machine of claim 1 in which:
a. said means for computing said set of products produces a first member of said set of products and a first intermediate term
b. said means for computing said set of products produces a second member of said set of products using said first intermediate term
c. said first intermediate term is not stored in said look-up table
whereby said means of computing said set of products for said look-up table can use shared multiplication in the form of shared intermediate terms in order to reduce implementation costs.

9. The machine of claim 1 in which:
a. said first number is a member of a strict subset of the values supported by the finite-precision numeric format of said first number, such as a number representing an input symbol from an input symbol constellation
b. said means for computing said set of products of said first number cannot compute the corresponding set of products for an arbitrary number representation in the finite-precision numeric format of said first number
whereby said means for computing said set of products can exploit known relationships among the possible values of said first number to compute said set of products of said first number with reduced cost.

10. The machine of claim 1 further including:
a. means for computing a set of products of a second number, said set of products having at least two members
b. means for storing said set of products of said second number in said lookup table in place of said set of products of said first number
whereby the memory locations of said look-up table can contain said set of products of said first number when said set of products of said first number is needed, and whereby the memory locations of said look-up table can contain said set of products of said second number when said set of products of said first number is no longer needed.

11. A method used in digital filtering, comprising:
a. computing a set of products of a first number, said set of products having at least two members
b. storing said set of products in a look-up table
c. accessing said look-up table to provide a first member of said set of products
d. computing a first product equal to the product of said first number and a first filter coefficient, using said first member of said set of products
e. accessing said look-up table to provide a second member of said set of products
f. computing a second product equal to the product of said first number and a second filter coefficient, using said second member of said set of products
whereby the computation method for said first product and the computation method for said second product both use members of said set of products from said look-up table, so that computational results are shared and multiplication implementation cost can be reduced.

12. The method of claim 11, further including:
a. computing a first output of said digital filter using said first product
b. computing a second output of said digital filter using said second product, said second output not being the same output as said first output
whereby said set of products stored in said look-up table can be used in computing outputs of said digital filter at more than one index value, even though the coefficients of the filter may change from index value to index value.

13. The method of claim 11 in which:
a. said first filter coefficient is a constant coefficient
b. said second filter coefficient is a constant coefficient
c. said set of products does not contain a subset of products from which the product of the first number and e very coefficient value can be computed
d. said set of products does contain a subset of products from which the product of the first number and every allowed coefficient can be computed
whereby said look-up table can be small in size and yet still contain the products necessary for computing said first product, said second product, and products of said first number and other coefficients of said digital filter.

14. The method of claim 11, in which said first filter coefficient is not a constant coefficient, further including computing a first output of said digital filter using said first product, whereby said look-up table can be used for shared multiplication and implementation cost reduction in computing outputs of adaptive filters.

15. The method of claim 11, further including adapting of parameter values of said digital filter, said adapting using said first product and said second product, said first product and said second product not being the same product, whereby said look-up table can be used for shared multiplication and corresponding implementation cost reduction in adaptive filters which use adaptation techniques such as least-mean-square (LMS) techniques, recursive least-square (RLS) techniques, fast RLS techniques, and Kalman techniques, among others.

16. The method of claim 11, further including:
a. computing a first output of said digital filter using said first product
b. adapting of parameter values of said digital filter using said second product
whereby said set of products stored in said look-up table can be used in computing an output of said digital filter and also in adaptive filters which use adaptation techniques such as least-mean-square (LMS) techniques, recursive least-square (RLS) techniques, fast RLS techniques, and Kalman techniques, among others.

17. The method of claim 11 in which:
a. said computing of said set of products produces a first member of said set of products
b. said computing said set of products produces a second member of said set of products using said first member
whereby said computing of said set of products for said look-up table can use shared multiplication in order to reduce implementation costs.

18. The method of claim 11 in which:
a. said computing of said set of products produces a first member of said set of products and a first intermediate term
b. said computing of said set of products produces a second member of said set of products using said first intermediate term
whereby said computing of said set of products for said look-up table can use shared multiplication in the form of shared intermediate terms in order to reduce implementation costs.

19. The method of claim 11 in which:
a. said first number is a member of a strict subset of the values supported by the finite-precision numeric format of said first number, such as a number representing an input symbol from an input symbol constellation
b. the method of said computing of said set of products of said first number cannot be used to compute the corresponding set of products for an arbitrary number representation in the finite-precision numeric format of said first number
whereby the method of said computing of said set of products can exploit known relationships among the possible values of said first number to compute said set of products of said first number with reduced cost.

20. The method of claim 11 further including:
a. computing a set of products of a second number, said set of products having at least two members
b. storing said set of products of said second number in said look-up table in place of said set of products of said first number
whereby the memory locations of said look-up table can contain said set of products of said first number when said set of products of said first number is needed, and whereby the memory locations of said look-up table can contain said set of products of said second number when said set of products of said first number is no longer needed.
